(19) United States
(12) Patent Application Publication
(10) Pub. No.: US 2017/0359964 A1
(43) Pub. Date: Dec. 21, 2017

(54) BASE TRAY FOR A PLANTER

(71) Applicant: Amy Persico, Farmingdale, NJ (US)

(72) Inventor: Amy Persico, Farmingdale, NJ (US)

(21) Appl. No.: 15/187,528

(22) Filed: Jun. 20, 2016

(51) Int. Cl. A01G 9/04

(52) U.S. Cl. CPC A01G 9/04

(57) ABSTRACT

A base tray apparatus for collecting and draining water overflow from a planter is disclosed. The base tray apparatus comprises a bottom surface with vertically extending sidewalls, to hold the planter or plant pot. A drainage outlet is attached to the bottom surface to facilitate the draining of excess water overflowing from the plant pot. The excess water is re-routed to another plant pot or drained to water absorbing ground surface thereby preventing the spillage of excess water in the deck area. Supporting legs are attached to the bottom of the tray to prevent accumulation of moisture underneath the base tray.

### FIELD OF THE INVENTION

The present invention relates to an apparatus and a method for draining excess water away from overwatered potted plants. In particular, the present invention relates to a base tray apparatus for supporting, hydrating, storing, transporting a planter or garden pot and draining of excess water from the planter pot thereby avoiding water spillage on floor or deck where the planter or potted plant is located.

### BACKGROUND OF THE INVENTION

Self-watering trays for garden plants or planters comprise its own water supply. The plant or a pot bearing the plant is placed on the bottom of the self-watering tray. The tray comprises a capillary matting made of a synthetic absorbent material and soil in the pot wicks up water via the capillary matting. The wicking process of the self-watering tray works through capillary action for absorbing water. However, setting up and maintaining these self-watering trays proves to be a tedious process and consumes a lot of time and needs personal assistance.

Other way of controlling water logging or overflow of water from planters comprises providing a drainage orifice or a valve or a hose-like tubular member to drain excess water from the reservoir to a suitable disposal site away from the area of the potted plant. Creating a reservoir of drained fluids, which allows the plant and soil to be well drained after being saturated or watered is an alternative method but a major problem that exists with this kind of reservoir is mosquito or other insects, which generally breeds in stagnant water.

Due to excess watering, overflow water spreads in and around the areas of garden pot or planter and the surrounding surface will be damaged by spillage or dripping of water. Devices for re-circulating the excess water in such a way that the overflowing water will be used again to water the same plant is considered as one of the easiest way to control the overflow. However, the above configuration needs additional support like pumps or other devices to re-circulate the excess water back into the soil inside the pot. In this case, the soil may not be dry enough to accept more water.

In light of aforementioned problems and limitations of the prior art references, there exists a need for an apparatus for potted garden plants or planters, which allows drainage of excess water by redirecting to another plant pot or to a water absorbing ground surface.

### SUMMARY OF THE INVENTION

Accordingly, it is an object of the present invention to provide a base tray to re-route excess water from overwatered plant pot to off-deck or another plant pot.

In one aspect of the present invention, the base tray comprises a bottom surface configured to hold the plant pot and prevent irrigated water from overflowing onto the deck, floor or other area. The bottom surface of the base tray is generally bowl-shaped to receive the overflowing water and further comprises a drainage outlet section extending outwardly on one of the sides facilitating draining or re-routing excess water to off-deck area or to another flower pot thus preventing water spillage. The bottom surface is attached with one or more supporting leg structures that extend downwards towards a ground surface. The supporting legs creates a space between the ground surface and the base tray, which prevents accumulation of moisture underneath the base tray.

In one aspect of the present invention, the base tray can be made out of a wide variety of materials such as plastic, polymer, clay and the like. The base tray can be manufactured in a wide variety of shapes and sizes. The unique design of the base tray helps to drain the excess water collected from over watered planters and prevents random water spillage on the deck as well as reduces potential water damage to the surroundings of the plant or plant pot.

In an embodiment, the base tray can be attached to the deck or rail or porch using an attachment. The base tray of the present invention requires no modification in the design to accommodate the standard plant pots.

### BRIEF DESCRIPTION OF DRAWINGS

FIG. 1 is a perspective view of the base tray holding a plant pot, according to an embodiment of the present invention.

FIG. 2 shows atop view of the base tray, according to an embodiment of the present invention.

### DETAILED DESCRIPTION OF THE INVENTION

The following detailed description of the different exemplary embodiments presents a description of certain specific embodiments to assist in understanding the claims. However, the present invention is intended to cover alternatives, modifications and equivalents, which may be included within the spirit and scope of the invention as defined by the appended claims.

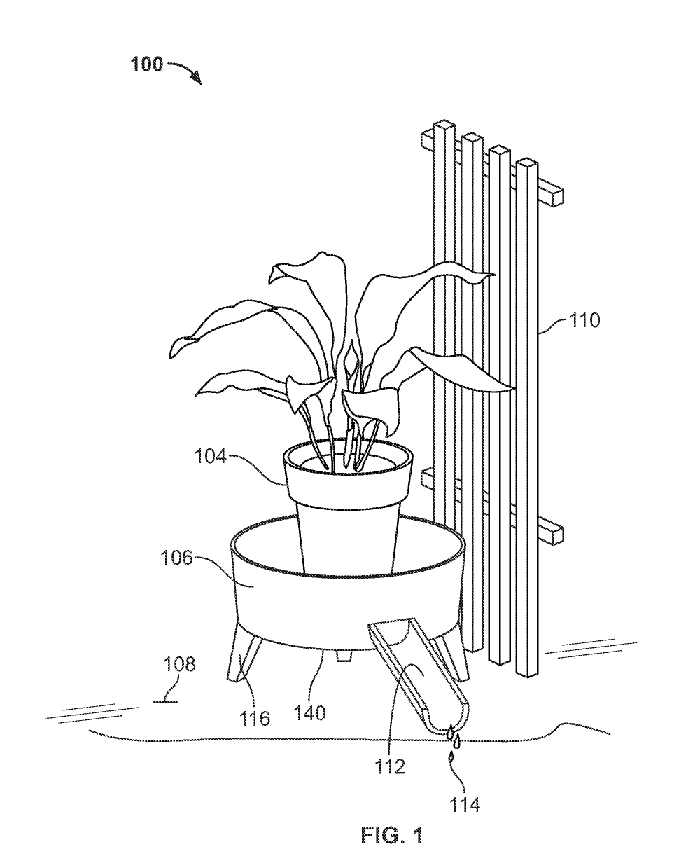

The base tray of the present invention, identified generally as 100 in the figures, is utilized with a planter or plant pot or flowerpot 104 that is substantially filled with soil, sand or gravel or mud or other plant growth material. As shown in FIG. 1, base tray 100 of the present invention is configured to drain excess water from the overwatered plant pot or flower pot 104. The base tray 100 comprises a round or oval shaped bottom to hold the plant pot or flower pot 104. The base tray 100 comprises a bottom surface 140 with one or more sidewalls 106 extending vertically upward from the circumferential edge of the bottom surface 140. As it is well known, the excess water that drains from the overwatered plant pot or flowerpot 104 will generally carry materials such as soil, fertilizer, chemicals and similar other materials from the plant pot or flower pot 104.

As set forth in more detail below, the plant pot 104 can be placed within the base tray 100 as shown in FIG. 1. A drainage outlet 112 comprising an open narrow channel sloping downwards, to permit the water shown as droplets 114 to easily flow out or drain from the base tray 100. The drainage outlet 112 is attached to bottom surface 140 level of base tray 100 so that there will not best agnation of collected water. The drainage outlet 112 can be made in any length desirable with a sufficient diameter allowing free flow of excess water shown as droplets 114 and allows easy cleaning. Generally, it will be desired to drain the water from the plant pot or flower pot 104 to a disposal site suitable or to an adjacent plant or to places such as garden or grass below deck rail 110 that can absorb the excess water. The base tray 100 is attached with supporting legs 116 extending from the bottom surface. The supporting legs creates a space between the base tray 100 and the ground surface or deck surface 108, which prevents accumulation of moisture underneath the base tray 100. In an embodiment, the supporting legs 116 are 1.5 inches in height. In an embodiment, the base tray 100 comprises 4 inches depth.

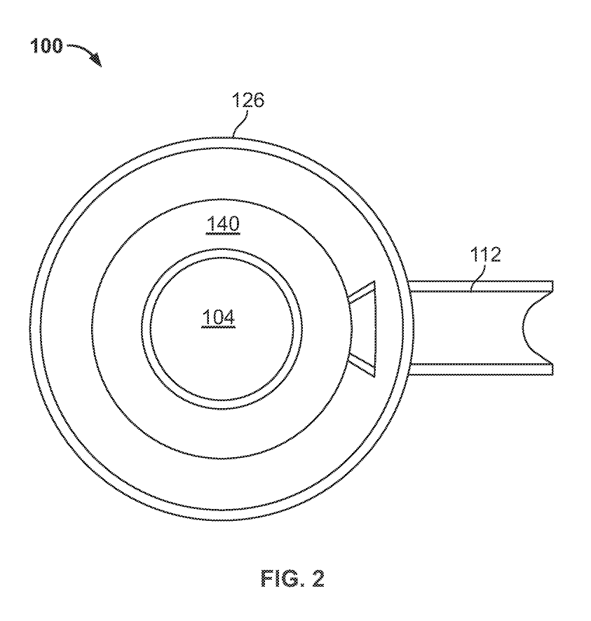

FIG. 2 shows a top view of the base tray 100, which comprises an outer surface 126 and the bottom surface 140 together forming an interior reservoir compartment in which the overflowing excess water is received. Drainage outlet 112 is configured to drain the excess or overflow water from the base tray 100. When plant pot 104 is placed and watered, any excess water will flow into the bottom surface 140 of the tray 100 and drains through the outlet 112 to a water absorbing ground surface or re-routed to another potted plant.

Accordingly, the base tray 100 is designed to be adaptable to hold a variety of pots that are varying in size and dimension. In an exemplary embodiment, the depth of base tray 100 may be approximately 6 inches. In one configuration, bottom surface 140 is configured in a generally circular shape or hemispherical and other variety of different shapes and sizes depending on the desired shape and/or size of plant pot 104 desired to be utilized with base plate tray 100. The tray 100 can be made out of a variety of different materials, including plastics, wood, clay, metal, composites, fiberglass and other materials that are suitable for supporting plant pot 104 as described herein.

In an embodiment, the base tray 100 can be preferably molded of suitable plastic or resinous material, such as acrylonitrile-butadiene-styrene or ABS, polyethylene or the like. The bottom surface 140 of the base tray 100 is configured to have bowl-shape to receive and store the overflowing water such that circulation of the water is kept away. This substantial feature allows saturation of plant or soil with water. A user may decide to position the base tray 100 and plant pot 104 with respect to the deck rail or stairs 110 as shown in FIG. 1. In one configuration, drainage outlet 112 is made of a plastic or hard material channel that is of the type that is commonly found and easy to alternate. First end of outlet 112 is connected to the body portion of the base tray 100 and the second end is directed to the desired drainage site. As plant pot or flowerpot 104 is watered, any excess water will drain through drainage outlet 112 and then disposed away from the plant pot or flowerpot 104. The disposed water is either re-routed to another plant pot or drained to the ground surface capable of absorbing excess water.

Although the present invention has been described herein in the context of a particular implementation in a particular environment for a particular purpose, those of ordinary skill in the art will recognize that its usefulness is not limited thereto and that the present invention may be beneficially implemented in any number of environments for any number of purposes. Accordingly, the claims set forth below should be construed in view of the full breadth and spirit of the present invention as described herein. Although specific terms may be employed herein, they are used in a generic and descriptive sense only and not for purposes of limitation.

1. A base tray for collecting and draining water overflow from a planter, the base tray comprising:
A bottom surface with one or more sidewalls extending vertically upward from the circumferential edge of the bottom surface, for collecting water overflowing from the planter;
a drainage outlet extending outwards from the bottom surface to drain or re-route the collected water into another planter; and
a plurality of supporting legs attached to the bottom surface for holding the base tray above a substantially planar ground surface.

2. The base tray of claim 1, wherein the bottom surface is round or oval shaped to hold a hemispherical plant pot.

3. The base tray of claim 1, wherein the drainage outlet is attached to the bottom surface with a degree of sloping.

4. The base tray of claim 1, is made from plastic or polymer suitable material.

5. A method of preventing water overflow from a planter, the method comprising the steps of:
providing a base tray with a bottom surface with one or more sidewalls and a drainage outlet extending outwards from the bottom surface;
positioning a planter within the base tray and watering the planter;
receiving overflowing water from the planter in the bottom surface of the base tray; and
re-routing the received water through the drainage outlet.

6. The method of claim 5, wherein the received water is re-routed to another planter.

7. The method of claim 5, wherein the received water is re-routed by draining into a water absorbing ground surface.
